(19) United States
(12) Patent Application Publication
(10) Pub. No.: US 2020/0403888 A1
(43) Pub. Date: Dec. 24, 2020

(54) METHODS, SYSTEMS, APPARATUSES AND DEVICES FOR FACILITATING PROVISIONING OF SERVICES TO AT LEAST ONE SERVICE-RECIPIENT BASED ON AT LEAST ONE REQUIREMENT

(71) Applicant: Krishna Kumari Selvaraj, Sugar Land, TX (US)

(72) Inventor: Krishna Kumari Selvaraj, Sugar Land, TX (US)

(21) Appl. No.: 16/450,497

(22) Filed: Jun. 24, 2019

(51) Int. Cl. H04L 12/24; G06N 20/00

(52) U.S. Cl. CPC H04L 41/5054; G06N 20/00; H04L 41/16; H04L 41/5051

(57) ABSTRACT

A system for facilitating provisioning of services to at least one service-recipient based on at least one requirement is disclosed. Accordingly, the system may include a communication device configured for receiving a service request data from at least one service-recipient device. The service request data may include budget data associated with the at least one service-recipient corresponding to the service request data. Further, the system may include a storage device configured for retrieving service records associated with the at least one service-recipient from a central database. Further, the system may include a processing device configured for analyzing the service records and the service request data to identify one or more service providers. Further, the one or more service providers may be configured to provide services satisfying the budget data. Further, the processing device may be configured for provisioning the services to the at least one service-recipient based on the analyzing.

### FIELD OF THE INVENTION

Generally, the present disclosure relates to the field of data processing. More specifically, the present disclosure relates to methods, systems, apparatuses and devices for facilitating provisioning of services to at least one service-recipient based on at least one requirement.

### BACKGROUND OF THE INVENTION

Traditional methods for providing services to customers include service-providers that stores service records (including data associated with customers and the services that are provided to the customer) at a service-provider end. The service records stored at the service provider end means that the data is not stored centrally with the customer. Therefore, the customer has to ask permission from the service provider whenever the customer may need to access the service records. Consequently, the customer may face discontinuity of the services while switching across the service providers, for e.g., to get the services that may be ideal for their budget.

Therefore, there is a need for improved methods, systems, apparatuses and devices for facilitating provisioning of services to at least one service-recipient based on at least one requirement that may overcome one or more of the above-mentioned problems and/or limitations.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Disclosed herein is a method of facilitating provisioning of services to at least one service-recipient based on at least one requirement, in accordance with some embodiment. Accordingly, the method may include receiving, using a communication device, a service request data from at least one service-recipient device associated with the at least one service-recipient. Further, the service request data may include budget data associated with the at least one service-recipient corresponding to the service request data. Further, the method may include retrieving, using a storage device, service records associated with the at least one service-recipient from a central database. Further, the service records may include at least one of service-recipient data and service provider data. Further, the central database may be accessible to each of the at least one service-recipient, and a plurality of service providers. Further, the method may include analyzing, using a processing device, the service records and the service request data to identify one or more service providers of the plurality of service providers. Further, the one or more service providers may be configured to provide services satisfying the budget data. Further, the method may include provisioning, using the processing device, the services to the at least one service-recipient based on the analyzing.

Further disclosed herein is a system for facilitating provisioning of services to at least one service-recipient based on at least one requirement, in accordance with some embodiment. Accordingly, the system may include a communication device configured for receiving a service request data from at least one service-recipient device associated with the at least one service-recipient. Further, the service request data may include budget data associated with the at least one service-recipient corresponding to the service request data. Further, the system may include a storage device configured for retrieving service records associated with the at least one service-recipient from a central database. Further, the service records may include at least one of service-recipient data and service provider data. Further, the central database may be accessible to each of the at least one service-recipient, and a plurality of service providers. Further, the system may include a processing device configured for analyzing the service records and the service request data to identify one or more service providers of the plurality of service providers. Further, the one or more service providers may be configured to provide services satisfying the budget data. Further, the processing device may be configured for provisioning the services to the at least one service-recipient based on the analyzing.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform consistent with various embodiments of the present disclosure.

FIG. 2 is a system for facilitating provisioning of services to at least one service-recipient based on at least one requirement, in accordance with some embodiment.

FIG. 3 is a flowchart of a method for facilitating provisioning of services to at least one service-recipient based on at least one requirement, in accordance with some embodiment.

FIG. 4 is a flowchart of a method to facilitate determining service-needs of at least one service-recipient, in accordance with some embodiment.

FIG. 5 is an exemplary representation of a system to facilitate providing services that a service-recipient (such as a customer) may want within a budget of the service-recipient, in accordance with some embodiment.

FIG. 6 is a block diagram of a computing device for implementing the methods disclosed herein, in accordance with some embodiments.

### DETAILED DESCRIPTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of provisioning of services to at least one service-recipient based on at least one requirement, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor and at least one actuator. Examples of the one or more client devices and/or the server computer may include, a desktop computer, a laptop computer, a tablet computer, a personal digital assistant, a portable electronic device, a wearable computer, a smart phone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third party database, public database, a private database and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role based access control, and so on.

Further, one or more steps of the method disclosed herein may be initiated, maintained, controlled and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g. username, password, passphrase, PIN, secret question, secret answer etc.) and/or possession of a machine readable secret data (e.g. encryption key, decryption key, bar codes, etc.) and/or or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera and so on. Likewise, the one or more steps may include receiving, using the communication device, the one or more embodied characteristics from one or more biometric sensors.

Further, one or more steps of the method may be automatically initiated, maintained and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device etc.) corresponding to the performance of the one or more steps, environmental variables (e.g. temperature, humidity, pressure, wind speed, lighting, sound, etc.) associated with a device corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor etc.), a biometric sensor (e.g. a fingerprint sensor), an environmental variable sensor (e.g. temperature sensor, humidity sensor, pressure sensor, etc.) and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data and any intermediate data therebetween corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

### Overview

The present disclosure includes systems and methods for facilitating provisioning of services to at least one service-recipient based on at least one requirement. Accordingly, the at least one requirement, in an instance, may include conditions that may need to be satisfied in order to provide an ideal service for the at least one service-recipient. For instance, the at least one requirement may include a budget constraint that may need to be satisfied for the provisioning of a service.

Further, the system, in an instance, may provide the services a customer wants or needs within customer's budget. Further, the service may be defined as a job that may involve time. Further, the service may also involve Tools/Equipment/Place, and Material/Parts. Further, the Tools/Equipment/Place, in an instance, may be things that may either be provided free or paid for rent to perform the service for a duration of the service. Further, the Tools/Equipment/Place, in an instance, may not be provided to the customer after service completion and a cost incurred by these may be included in a service cost. Further, the Material/Parts, in an instance, may be things that may need replacement and may be given to the customer after the service completion. Further, the Material/Parts, in an instance, may be charged to the customer apart from the service cost.

Further, the services may be primarily divided into seven service types (for e.g. service type A-G). Further, the service types, in an instance, may involve two parties (for e.g. one a customer and another a provider). For instance, the service type A may include a human providing a service to another human. Further, the service type B may include a human providing a service to a thing (and/or an object). Further, the service type C may include a human providing a service to an animal. Further, the service type D may include a robot or computer system providing services to a human and vice versa. Further, the service type E may include a robot or computer system providing services to a thing. Further, the service type F may include a robot or computer system providing services to an animal Further, the service type G may include a human providing a service to himself, thing or animal by himself. Further, the Service Type G may also be called DIY (Do It Yourself) services or self-services which may only involve one party; i.e. the provider and customer may be same. Further, the service type G, in an instance, may require a second party namely a trainer and/or training material for a single party to do the service themselves.

Further, the services may be classified into one or more service varieties (such as an enhancement service, a preventive service, an on-demand service, and a delayed service). Further, a word “item” may be used to describe the human, thing or animal being serviced as described in the service types. Further, the enhancement services, in an instance, may be services that a service-recipient doesn't have currently, and may want a new and/or enhance an item that the service-recipient may already have. Further, the enhancement services, in an instance, may require measurements, quality aspects, etc. before a price may be determined. Further, the preventive services, in an instance, may be services that may be provided for an item, that the service-recipient already has, before any issue occurs (that causes the item to be non-functional). Further, the preventive services, in an instance, may be scheduled periodically. Further, a price associated with the preventive services, in an instance, may be determined based on specific nature of the service. Further, the on-demand services, in an instance, may be services that need to be done after an item may have failed. Further, the on-demand services, in an instance, may be required immediately and may not be postponed. Further, a price associated with the on-demand services, in an instance, may be determined after an initial analysis, so a combination of a diagnostic service and specific services may be required to determine a total price. Further, the delayed services, in an instance, may be services that may not need to be done on demand but still need to be done at some point. Further, a price associated with the delayed services, in an instance, may be determined immediately or a combination of a diagnostic service and specific services. Further, the use of word service in the subsequent sections may mean the different service types as well as the one or more service varieties.

Further, the services may be provided to a customer for a price, subsidized or free. Further, even a free price may still be considered a price for this discussion. This could be rendered by a volunteer.

Further, every customer may like to obtain all services that the customers may be interested in within customer's budget. Further, the service providers, in an instance, may wish to provide the services to the customers for price points that may satisfy the customer and may also meet business objectives of the service provider.

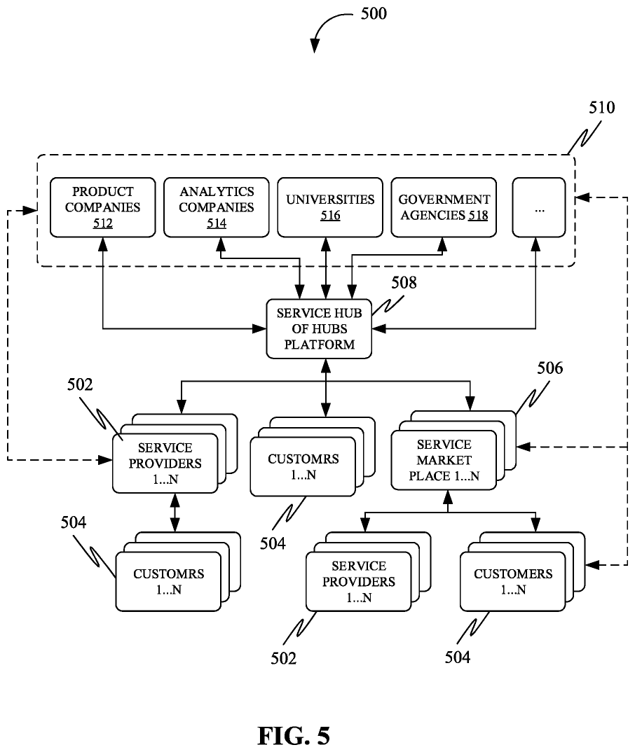

Further, FIG. 5 describes a way to provide Centralized Services and Service Records to the customers. Accordingly, the service providers, in an instance, may directly provide services to the customers. Further, there could be many such service providers and their customers. Further, a service market place, in an instance, may connect both the service providers and the customers. Further, the service market place, in an instance, may be referred to as a service hub. Further, the service market place may offer a specific service, few or most services that the customer may need. Further, there may be many such service market place providers. Further, a service Hub of Hubs Platform, in an instance, may connect multiple service hubs, service providers and the customers, and/or may directly connect the customers to any of these above.

Further, the system may be configured to provide the services that the customer may want within a budget (customer's budget). Accordingly, using consolidated data across all the service providers and service provider's location, the service hub of hub platform may be able to look through all the services and may collect different services that the customer wants. This may be achieved by solving the customer's request with a single service provider, multiple service providers, a service hub, multiple service hubs or the service hub of hubs. Further, the data may be services and details associated with the services, content about the services, such as (but not limited to) blogs, media content like images, audio recordings, videos, provider details and experience, peer provider reviews, customer-generated content like feedback, questions, media content, referrals etc. Any data relevant in picking the services the customer wants, in an instance, may be collected that may satisfy the budget the customer has along with a quality expected in that budget. Further, involvement of various parties may result in establishment of collaborations and partnerships to satisfy an overall goal.

Further, in case the data may not be consolidated, a reference to the data may be present in a central hub of hubs while the other may be with individual hubs. Further, the central hub of hubs may query the individual hub to satisfy the condition specifically for that individual hub.

Further, the goal, in an instance, may be to provide an unbiased solution, if biased solutions may be provided due to promotions, lack of data, prediction, etc., those needs to be called out explicitly to the customers. Further, the service provider, in an instance, may be responsible for clearly providing the quality aspects in a quantitative way for the customers to understand and agree (for e.g. star ratings, and/or number proportional with the quality of the services provided). Further, the quality, in an instance, may be measurable in case the customer may be dissatisfied with the service and an argument occurs so that both parties may agree on an outcome. Further, in case of discrepancies, a customer's view may be final, and the service provider may agree and/or disagree on the customer's view. Further, a suitable mechanism may also be in place to govern customer abusing such privileges.

Further, the system may allow the user to switch between service providers who may offer the services with the help of centralized service records. Accordingly, unlike traditional methods of service records which may only be available at the service provider and shared with other service providers upon request. The service records may have two components namely a data (a customer data) which may be specific to the customer which the customer owns and a data (a service provider data) which may be specific to the service provider that the service provider owns. Further, the goal is to have records centrally with the customer and the customer-owned data may be shared with the service provider during the period of service by customer's consent. Further, the customer may continue to own the service records and may access the service records anytime without having to ask permission from the service provider. Further, the service provider data that may be specific to the service provider may be obtained with permission from the service provider. Further, the service record, in an instance, may be a common record that may be of value to the customers and to other service providers. Accordingly, a continuity of the service even when switching across the service providers may be maintained.

Further, the system may be configured to find the services that the customer needs within the budget. This is different from what the customer wants (which is a pull model). This refers to a push model of identifying services which the customer may need by analyzing the data in the customer's location and recommending to the customer or made compulsory by a Government agency etc. Further, the push model may be obtained using the services provided, service providers and the historical data that may be present with other services of similar type. Further, identification of the services may be done either using manual inferred model from experts or machine learning artificial intelligence models.

Further, the system may allow the service provider to improve the services offered by the service provider. Accordingly, using existing data across the services and service providers, a serviced provider may optimize a cost and related quality of the service provided to the customer. Further, the service provider may also improve the services provided in other means by comparing the services offered by other service providers, track what happened after providing the service and how often the services may be recurring in case of the service provider or other service providers who provided this service. Further, the data may also be mined specifically to assist in service provider improving the services.

Further, the service hub of hubs platform may have data about the services, service profession, locations, customers, pricing, service records, service review, etc. Accordingly, by having information about the service (such as products) and how the products may be performing with the various customers and service providers, a product company may enhance the products or find new products to service the needs of the customer. Further, in another instance, analytical companies may use the data to enhance the services. For instance, by distributing the data (anonymized data), more insights may be learned about which services may be requested all the time, in which location, etc. Further, the ratio of service providers to customers. The products, people, animal, etc. that require frequent service may be identified. There may be many use cases for the data. Further, in another instance, universities may use the data. For instance, by using the data the universities may identify which service professions may be in demand, not in demand or shortage. By identifying professionals that may be of shortage, the universities may target these group and provide courses to identify the demand. Further, the same may be done to improve knowledge of the professions that may be in demand. Further, students may also validate the demand and take up courses. Further, in another instance, using the various data that may affect citizens in various locations, government agencies may take measures or enact regulations that may help the citizens. Further, the government agencies, in an instance, may also better understand the details about each service and how the service may assist the citizens and provide incentives to both the service providers and the customers depending on how the services may be optimizing government expenditure.

Further, an example of a day service request is disclosed. Accordingly, in an instance, Mr. and Mrs. Smith have 2 children namely Jane who is 6 years old and Jim who is 8 years old. Further, Mr. and Mrs. Smith would like one or more services for a Friday in April. Further, the one or more services, in an instance, may include services such as an experienced Baby Sitter between 3.30 pm to 6:00 pm, To take Mrs. Smith to a beauty Parlor at 12:30 pm from their home and she would like her hair color done from a seasoned hair stylist, and To have satisfactory dinner at 8:30 pm in a 3-course meal along with pizza for their kids at a nearby Italian restaurant. Further, a total they are willing to spend is $350.

Further, another example of a monthly service request is disclosed. Accordingly, in an instance, Mr. and Mrs. Smith along with their two children have a home and two cars. Further, Mr. and Mrs. Smith would like to avail the following services on a monthly basis, such as a house cleaning service once a week, a lawn cutting service fortnightly, a car cleaning service once a week, a gardening service fortnightly, and hair cutting service for Mr. Smith and their two children once a month. Further, a total they are willing to spend is $650.

Further, the requests, in an instance, may continue for other time-bound durations ranging from minutes to years.

Further, the services hub of hubs platform, using network, may check if Mr. and Mrs. Smith may have availed these services before, if the services exist then, the services hub of hubs platform may provide these services that would meet the budget. If the services don't exist, the services hub of hubs platform may check other similar families that may have availed the services in the location and presents the services. If none found, the services hub of hubs platform may look through the services and find a fit to meet the request. If the services hub of hubs platform can't, the services hub of hubs platform may recommend reduction of services to fit the budget or increasing the budget to meet the services required.

For instance, for the experienced baby sitter, seasoned hair stylist and satisfactory dinner, the services hub of hubs platform may rely on other means to fulfill the request, such as by gathering data from others who have been serviced by these providers.

Further, for the monthly service request, the services hub of hubs platform may multiply the service requests by the duration requested or may work with the service providers and may look at negotiated prices if paid in bulk as opposed to single service interaction and present options for the customer to choose.

Further, in a case if the services hub of hubs platform may not able to find a solution or the customer may not be pleased with the solution, the services hub of hubs platform may facilitate the customer asking other customers for recommendation or other providers who may satisfy such conditions manually using the data in the services hub of hubs platform with or without a compromise on the services requested.

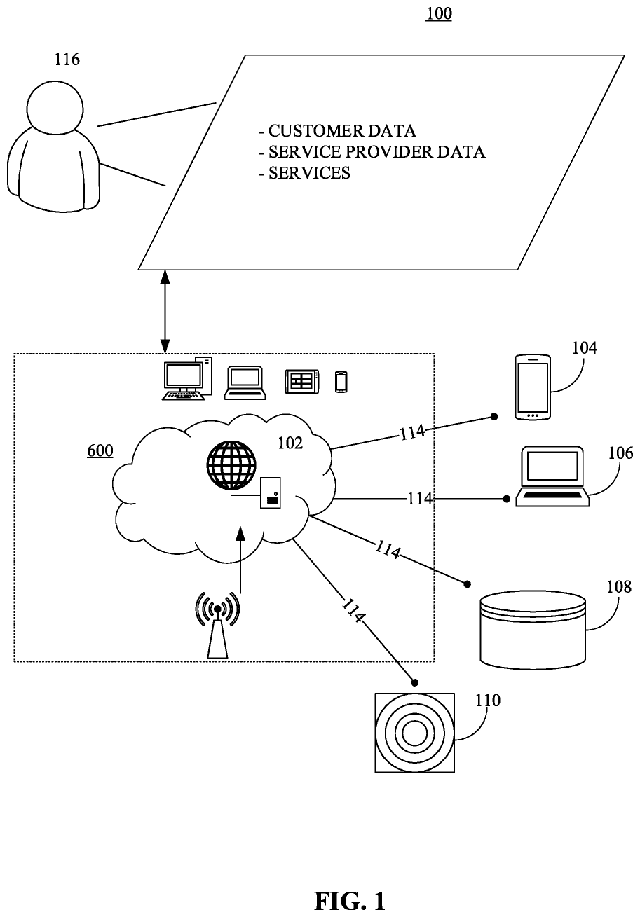

FIG. 1 is an illustration of an online platform 100 consistent with various embodiments of the present disclosure. By way of non-limiting example, the online platform 100 to facilitate provisioning of services to at least one service-recipient based on at least one requirement may be hosted on a centralized server 102, such as, for example, a cloud computing service. The centralized server 102 may communicate with other network entities, such as, for example, a mobile device 104 (such as a smartphone, a laptop, a tablet computer etc.), other electronic devices 106 (such as desktop computers, server computers etc.), databases 108, and sensors 110 over a communication network 114, such as, but not limited to, the Internet. Further, users of the online platform 100 may include relevant parties such as, but not limited to, end users, administrators, service providers, service consumers and so on. Accordingly, in some instances, electronic devices operated by the one or more relevant parties may be in communication with the platform.

A user 116, such as the one or more relevant parties, may access online platform 100 through a web based software application or browser. The web based software application may be embodied as, for example, but not be limited to, a website, a web application, a desktop application, and a mobile application compatible with a computing device 600.

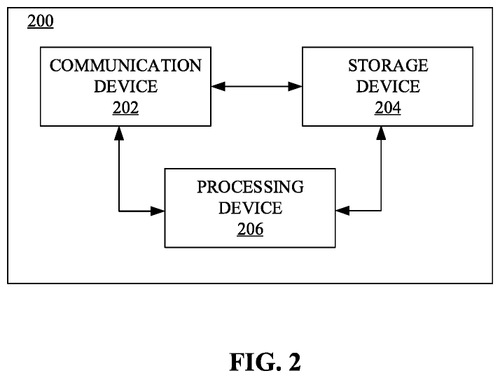

FIG. 2 is a system 200 for facilitating provisioning of services to at least one service-recipient based on at least one requirement, in accordance with some embodiment. Accordingly, the system 200 may include a communication device 202 configured for receiving a service request data from at least one service-recipient device associated with the at least one service-recipient. Further, the service request data may include budget data associated with the at least one service-recipient corresponding to the service request data. Further, in some embodiments, the at least one service-recipient may include at least one of a human, an animal, and an object.

Further, the system 200 may include a storage device 204 configured for retrieving service records associated with the at least one service-recipient from a central database. Further, the service records may include at least one of service-recipient data and service provider data. Further, the central database may be accessible to each of the at least one service-recipient, and a plurality of service providers.

Further, the system 200 may include a processing device 206 configured for analyzing the service records and the service request data to identify one or more service providers of the plurality of service providers. Further, the one or more service providers may be configured to provide services satisfying the budget data. Further, in some embodiments, the services may include at least one of an enhancement service, a preventive service, an on-demand service, and a delayed service. Further, the enhancement services, in an instance, may be services that a service-recipient doesn't have currently, and may want a new and/or enhance an item that the service-recipient may already have. Further, the enhancement services, in an instance, may require measurements, quality aspects, etc. before a price may be determined. Further, the preventive services, in an instance, may be services that may be provided for an item, that the service-recipient already has, before any issue occurs (that causes the item to be non-functional). Further, the preventive services, in an instance, may be scheduled periodically. Further, a price associated with the preventive services, in an instance, may be determined based on specific nature of the service. Further, the on-demand services, in an instance, may be services that need to be done after an item may have failed. Further, the on-demand services, in an instance, may be required immediately and may not be postponed. Further, a price associated with the on-demand services, in an instance, may be determined after an initial analysis, so a combination of a diagnostic service and specific services may be required to determine a total price. Further, the delayed services, in an instance, may be services that may not need to be done on demand but still need to be done at some point. Further, a price associated with the delayed services, in an instance, may be determined immediately or a combination of a diagnostic service and specific services.

Further, the processing device 206 may be configured for provisioning the services to the at least one service-recipient based on the analyzing. Further, in some embodiments, the provisioning of the services may include using a service-provisioning bot. Further, in some embodiments, the services may be provided by at least one of a human, a bot, and by oneself.

In some embodiments, the communication device 202 may be further configured for transmitting the service provider data to the at least one service-recipient device associated with the at least one service-recipient.

Further, in some embodiments, the service-recipient data associated with the at least one service-recipient may be shared with the one or more service providers for a predetermined service period based on a service-recipient consent.

Further, in some embodiments, the central database may be accessible to at least one of one or more product companies, one or more analytical companies, one or more universities, one or more government agencies, one or more service market places, and one or more customers. Further, in some embodiments, the service records may include data about at least one service, at least one service profession, at least one location, and pricing.

In some embodiments, the processing device 206 may be further configured for analyzing the service records associated with the at least one service-recipient using at least one of Artificial Intelligence (AI), and machine learning. Further, the processing device 206 may be configured for predicting a service-need of the at least one service-recipient based on the analyzing. Further, the processing device 206 may be configured for generating recommendation data based on the predicting. Further, the communication device 202 may be configured for transmitting the recommendation data to the at least one service-recipient device associated with the at least one service-recipient.

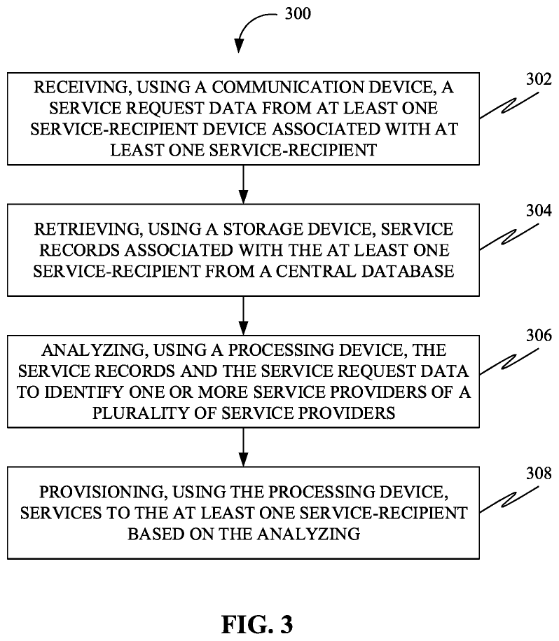

FIG. 3 is a flowchart of a method 300 for facilitating provisioning of services to at least one service-recipient based on at least one requirement, in accordance with some embodiment. Accordingly, at 302, the method 300 may include receiving, using a communication device (such as the communication device 202), a service request data from at least one service-recipient device associated with the at least one service-recipient. Further, the service request data may include budget data associated with the at least one service-recipient corresponding to the service request data. Further, in some embodiments, the at least one service-recipient may include at least one of a human, an animal, and an object.

Further, at 304, the method 300 may include retrieving, using a storage device (such as the storage device 204), service records associated with the at least one service-recipient from a central database. Further, the service records may include at least one of service-recipient data and service provider data. Further, the central database may be accessible to each of the at least one service-recipient, and a plurality of service providers.

Further, at 306, the method 300 may include analyzing, using a processing device (such as the processing device 206), the service records and the service request data to identify one or more service providers of the plurality of service providers. Further, the one or more service providers may be configured to provide services satisfying the budget data. Further, in some embodiments, the services may include at least one of an enhancement service, a preventive service, an on-demand service, and a delayed service.

Further, at 308, the method 300 may include provisioning, using the processing device, the services to the at least one service-recipient based on the analyzing. Further, in some embodiments, the provisioning of the services may include using a service-provisioning bot. Further, in some embodiments, the services may be provided by at least one of a human, a bot, and by oneself.

Further, in some embodiments, the method 300 may include transmitting, using the communication device, the service provider data to the at least one service-recipient device associated with the at least one service-recipient.

Further, in some embodiments, the service-recipient data associated with the at least one service-recipient may be shared with the one or more service providers for a predetermined service period based on a service-recipient consent.

Further, in some embodiments, the central database may be accessible to at least one of one or more product companies, one or more analytical companies, one or more universities, one or more government agencies, one or more service market places, and one or more customers. Further, in some embodiments, the service records may include data about at least one service, at least one service profession, at least one location, and pricing.

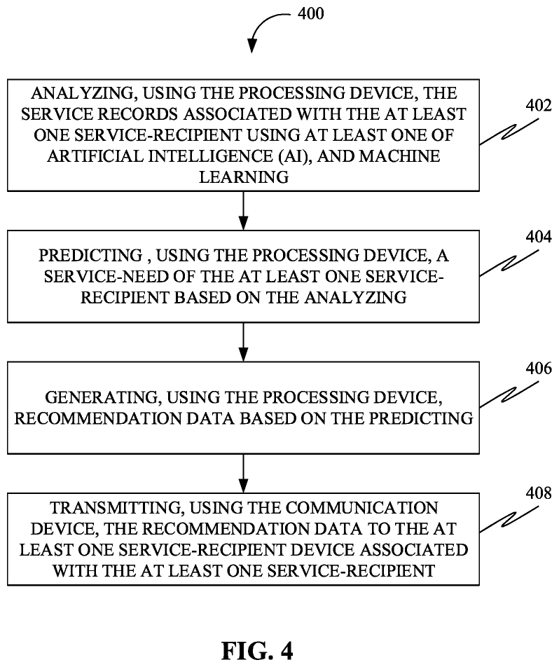

FIG. 4 is a flowchart of a method 400 to facilitate determining service-needs of the at least one service-recipient, in accordance with some embodiment. Accordingly, at 402, the method 400 may include analyzing, using the processing device, the service records associated with the at least one service-recipient using at least one of Artificial Intelligence (AI), and machine learning.

Further, at 404, the method 400 may include predicting, using the processing device, a service-need of the at least one service-recipient based on the analyzing.

Further, at 406, the method 400 may include generating, using the processing device, recommendation data based on the predicting.

Further, at 408, the method 400 may include transmitting, using the communication device, the recommendation data to the at least one service-recipient device associated with the at least one service-recipient.

FIG. 5 is an exemplary representation of a system 500 to facilitate providing services that a service-recipient (such as a customer) may want within a budget of the service-recipient, in accordance with some embodiment. Accordingly, the service, in an instance, may include different service types as well as service varieties (such as, but not limited to, an enhancement service, a preventive service, an on-demand service, and a delayed service). Further, the service may be provided to a customer for a price, subsidized or free. Further, even a free price may still be considered a price in the present disclosure. Further, the service-recipient, in an instance, may wish to obtain all services that the service-recipient may be interested in within the budget. Further, a win-win situation may be achieved when a service provider may provide services for the customers for the price that may satisfy the customer and may also meet business objectives of the service providers. Further, in some embodiments, one or more service providers 502 may directly provide services to one or more customers 504. Further, in some embodiments, one or more service market places 506 (and/or may be referred as a service hub), in an instance, may connect both the one or more service providers 502 and the one or more customers 504. Further, the one or more service market places 506, in an instance, may offer a specific service, few or most services that the one or more customers 504 may need. Further, in some embodiments, a service Hub of Hubs Platform 508, in an instance, may connect the one or more service hubs, the one or more service providers 502 and the one or more customers 504 and/or may directly connect customers to any of these above. Further, in some embodiments, the service Hub of Hubs Platform 508, in an instance, may be configured to communicate with one or more external platforms 510. Further, the one or more external platforms 510 may include platforms associated with entities such as (but not limited to) product companies 512, analytical companies 514, universities 516, and government agencies 518, etc.

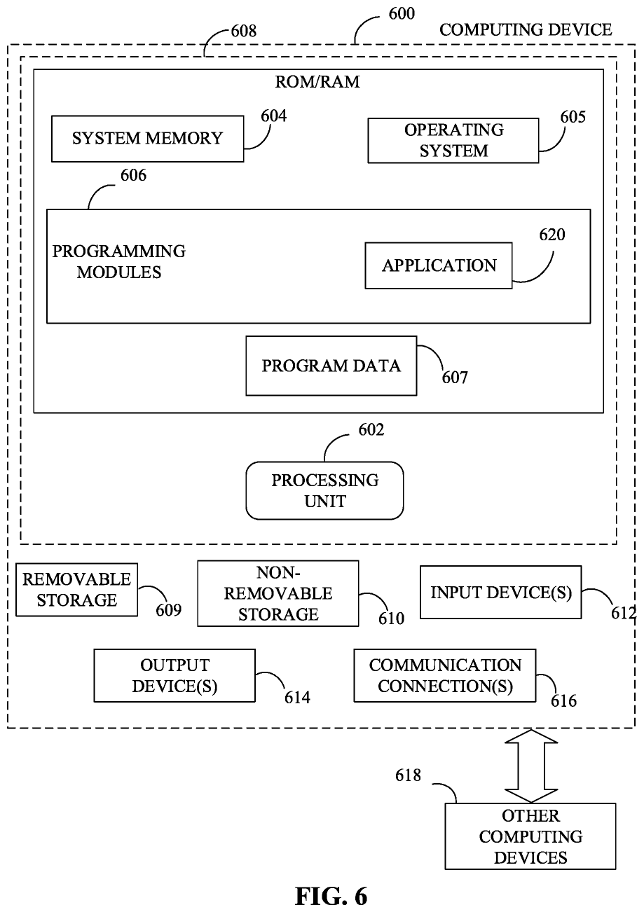

With reference to FIG. 6, a system consistent with an embodiment of the disclosure may include a computing device or cloud service, such as computing device 600. In a basic configuration, computing device 600 may include at least one processing unit 602 and a system memory 604. Depending on the configuration and type of computing device, system memory 604 may comprise, but is not limited to, volatile (e.g. random-access memory (RAM)), non-volatile (e.g. read-only memory (ROM)), flash memory, or any combination. System memory 604 may include operating system 605, one or more programming modules 606, and may include a program data 607. Operating system 605, for example, may be suitable for controlling computing device 600's operation. In one embodiment, programming modules 606 may include image-processing module, machine learning module. Furthermore, embodiments of the disclosure may be practiced in conjunction with a graphics library, other operating systems, or any other application program and is not limited to any particular application or system. This basic configuration is illustrated in FIG. 6 by those components within a dashed line 608.

Computing device 600 may have additional features or functionality. For example, computing device 600 may also include additional data storage devices (removable and/or non-removable) such as, for example, magnetic disks, optical disks, or tape. Such additional storage is illustrated in FIG. 6 by a removable storage 609 and a non-removable storage 610. Computer storage media may include volatile and non-volatile, removable and non-removable media implemented in any method or technology for storage of information, such as computer-readable instructions, data structures, program modules, or other data. System memory 604, removable storage 609, and non-removable storage 610 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 600. Any such computer storage media may be part of device 600. Computing device 600 may also have input device(s) 612 such as a keyboard, a mouse, a pen, a sound input device, a touch input device, a location sensor, a camera, a biometric sensor, etc. Output device(s) 614 such as a display, speakers, a printer, etc. may also be included. The aforementioned devices are examples and others may be used.

Computing device 600 may also contain a communication connection 616 that may allow device 600 to communicate with other computing devices 618, such as over a network in a distributed computing environment, for example, an intranet or the Internet. Communication connection 616 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 604, including operating system 605. While executing on processing unit 602, programming modules 606 (e.g., application 620 such as a media player) may perform processes including, for example, one or more stages of methods, algorithms, systems, applications, servers, databases as described above. The aforementioned process is an example, and processing unit 602 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the present disclosure has been explained in relation to its preferred embodiment, it is to be understood that many other possible modifications and variations can be made without departing from the spirit and scope of the disclosure.

1. A method for facilitating provisioning of services to at least one service-recipient based on at least one requirement, wherein the method comprises:
receiving, using a communication device, a service request data from at least one service-recipient device associated with the at least one service-recipient;
wherein the service request data comprise budget data associated with the at least one service-recipient corresponding to the service request data;
wherein the at least one service-recipient comprises at least one of a human, an animal and an object;
retrieving, using a storage device, service records associated with the at least one service-recipient from a central database;
wherein the central database is accessible to at least one of one or more product companies, one or more analytical companies, one or more universities, one or more government agencies, one or more service market places and one or more customers;
wherein the service records comprise at least one of service-recipient data associated with the at least one service-recipient and service provider data;
wherein the service provider data comprise at least one service type, at least one service profession, at least one service location and at least one service pricing;
wherein the central database is accessible to each of the at least one service-recipient, and a plurality of service providers;
transmitting, using the communication device, the service provider data to the at least one service-recipient device associated with the at least one service-recipient;
analyzing, using a processing device, the service records and the service request data to identify one or more service providers of the plurality of service providers by:
analyzing, using the processing device, the service records and the service request data via machine learning;
predicting, using the processing device, a service-need of the at least one service-recipient;
generating, using the processing device, recommendation data; and
transmitting, using the communication device, the recommendation data to the at least one service-recipient device;
wherein the one or more service providers are configured to provide services satisfying the budget data;
wherein the service-recipient data is shared with the one or more service providers for a predetermined service period based on a service-recipient consent;
wherein the services comprise at least one of an enhancement service, a preventive service, an on-demand service and a delayed service;
provisioning, using the processing device, the services to the at least one service-recipient; and
wherein the services are provided by at least one of a human, a service-provisioning bot and by oneself.

2. (canceled)

3. (canceled)

4. (canceled)

5. (canceled)

6. (canceled)

7. (canceled)

8. (canceled)

9. (canceled)

10. (canceled)

11. A system for facilitating provisioning of services to at least one service-recipient based on at least one requirement, wherein the system comprises:
a communication device;
a storage device;
a processing device;
wherein the system is configured for:
receiving, using the communication device, a service request data from at least one service-recipient device associated with the at least one service-recipient;
wherein the service request data comprise budget data associated with the at least one service-recipient corresponding to the service request data;
wherein the at least one service-recipient comprises at least one of a human, an animal and an object;
retrieving, using the storage device, service records associated with the at least one service-recipient from a central database;
wherein the central database is accessible to at least one of one or more product companies, one or more analytical companies, one or more universities, one or more government agencies, one or more service market places and one or more customers;
wherein the service records comprise at least one of service-recipient data associated with the at least one service-recipient and service provider data;
wherein the service provider data comprise at least one service type, at least one service profession, at least one service location and at least one service pricing;
wherein the central database is accessible to each of the at least one service-recipient, and a plurality of service providers;
transmitting, using the communication device, the service provider data to the at least one service-recipient device associated with the at least one service-recipient;
analyzing, using the processing device, the service records and the service request data to identify one or more service providers of the plurality of service providers by:
analyzing, using the processing device, the service records and the service request data via machine learning;
predicting, using the processing device, a service-need of the at least one service-recipient;
generating, using the processing device, recommendation data; and
transmitting, using the communication device, the recommendation data to the at least one service-recipient device;
wherein the one or more service providers are configured to provide services satisfying the budget data;
wherein the service-recipient data is shared with the one or more service providers for a predetermined service period based on a service-recipient consent;
wherein the services comprise at least one of an enhancement service, a preventive service, an on-demand service and a delayed service;
provisioning, using the processing device, the services to the at least one service-recipient; and
wherein the services are provided by at least one of a human, a service-provisioning bot and by oneself.

12. (canceled)

13. (canceled)

14. (canceled)

15. (canceled)

16. (canceled)

17. (canceled)

18. (canceled)

19. (canceled)

20. (canceled)
